(19) United States
(12) Patent Application Publication
(10) Pub. No.: US 2013/0343246 A1
(43) Pub. Date: Dec. 26, 2013

(54) Using VOIP call pickup for optimized incoming call treatment on mobile devices

(71) Applicant: Power2Mobility, (US)

(72) Inventors: Konstantin Manyakin, JR., Toronto (CA); Adiel Rozinov, Richmond Hill (CA)

(73) Assignee: POWER2MOBILITY, Toronto (CA)

(21) Appl. No.: 13/705,102

(22) Filed: Dec. 4, 2012

Related U.S. Application Data
(60) Provisional application No. 61/568,152, filed on Dec. 8, 2011.

(51) Int. Cl. H04M 7/00

(52) U.S. Cl. CPC H04M 7/0075
USPC 370/310

(57) ABSTRACT

A proposed method and system provide a way of receiving incoming VOIP call without maintaining of permanent SIP registration. To keep pinhole opened at firewall, VOIP client should always run in background and use additional mechanisms (keep alive, registration refreshes, persistent connection, etc) which shorten end point device battery life.

A method and system employs a mobile phone which equipped with mobile application that can receive notification about incoming call and telephony server which can send notification about incoming call. Upon receiving notification device establishes a VOIP pickup call to the server. Parameters of pickup call can be either pre-provisioned or can be passed to the device by the server in notification message. Replaces header can be used, but other proprietary mechanisms can be used as well. Server holds incoming call until it receives an incoming VOIP pickup call from the user device and after that completes a call.

### CROSS-REFERENCE TO RELATED APPLICATIONS

This application claims the benefit of Applicants' prior provisional application, number [61/568,152], filed on [Dec. 8, 2011].

### MICROFICHE APPENDIX

Not Applicable.

### TECHNICAL FIELD OF INVENTION

This application relates in general to providing of communications services and, in particular, to a method and system for receiving incoming VOIP call without maintaining of permanent SIP registration.

### BACKGROUND OF THE INVENTION

In the context of mobile network and VOIP over data connection to receive incoming VOIP call the end point should inform server regarding its current location.

Known methods which based on popular SIP standards require that the end point should inform server regarding its current location using mechanism of SIP registration. This registration should be permanently maintained which requires VOIP application on device to be permanently running. In addition to keep pinhole open at firewall, VOIP client should use additional mechanisms (keep alive, registration refreshes, persistent connection, etc). All that result in using resources of mobile device and shorter battery life. In addition, many mobile OS don't allow applications to run on background or may unload application in arbitrary manner.

As a solution many VOIP application leverage ‘registration on demand’ approach when application is either awaken or activated by push notification sent by the server. Once awaken/activated application sends registration requests and server route call to the device based on this registration. This approach causes significant delays for accepting incoming calls because it requires propagating a registration request from the device to the server and than a call request from the server to the device.

There therefore exists a need for a method and system that provides an effective way of accepting incoming VOIP calls without maintaining permanent registration which save the battery life and can be also time efficient.

There therefore exists a need for service providers to enable a method and system that can establish a call to their customers by answering incoming VOIP call through VOIP pick up call without maintaining of permanent SIP registration and therefore reduce the power consumption on the phone and reduce the delay of answering the call.

### BRIFF SUMMARY OF THE INVENTION

It is therefore an object of the invention to provide a method and a system for receiving incoming VOIP call without maintaining of permanent SIP registration.

The invention therefore provides a method for receiving incoming VOIP call without maintaining of permanent SIP registration comprising: receiving initial incoming VOIP call through the call control application server (CCAS); keeping this initial call request by CCAS and notifying user's mobile phone equipped with mobile application by sending notification to this application; retrieving of parameters of pickup call from notification message or from configuration on the phone by mobile application; making a VOIP pickup call from this mobile phone with appropriate parameters (Replaces header can be used, but other proprietary mechanisms can be used as well); holding initial incoming call until CCAS receives an incoming VOIP pickup call from the user device and after that completing the call.

The invention further provides a system for receiving incoming VOIP call without maintaining of permanent SIP registration, comprising: a mobile phone equipped with application client programmed to: monitor notification about incoming VOIP calls from a call control server (CCAS); retrieve parameters of pickup call from notification message or from configuration on the phone by mobile application; make a VOIP pickup call from this mobile phone with appropriate parameters (Replaces header can be used, but other proprietary mechanisms can be used as well); and a call control application server (CCAS), comprising a service programmed to: receive initial incoming VOIP call; keep this initial call request and send notification about the call request to the application on user's mobile phone; wait for incoming VOIP pickup call from the subscriber mobile phone; correlate this VOIP pickup call request with initial VOIP incoming call based on information provided in VOIP pickup call and complete the connection between them.

The invention further provides a mobile handset application client, comprising: program instructions for receiving notification from the server about incoming VOIP call through different notification mechanisms; retrieving parameters of VOIP pickup call from this notification message or from local configuration prior to initiating of VOIP pickup call; making a VOIP pickup call from this mobile phone with appropriate parameters (Replaces header can be used, but other proprietary mechanisms can be used as well).

The invention yet further provides a call control application server, comprising: a service application that is receiving VOIP incoming call to subscriber; instead of sending call to the device sending notification to the device by using push notification, SMS or another mechanism; keeping (parking) this initial received incoming call request while waiting for incoming VOIP call pick up from the subscriber phone; correlates this VOIP pickup call request with initial VOIP incoming call based on information provided in VOIP pickup call; completes the call setup request to connect the subscriber to the initial VOIP incoming call.

### BRIEF DESCRIPTION OF THE DRAWINGS

The accompanying drawings incorporated in and forming a part of this specification illustrate several aspects of the invention, and together with the description serve to explain the principles of the invention.

FIG. 1 is a block representation of a communication environment according to one embodiment of the disclosure.

FIG. 2 provides an exemplary communication flow according to the embodiment of the disclosure which used short messaging as notification mechanism.

FIG. 3 provides an exemplary communication flow according to the embodiment of the disclosure which used push messaging as notification mechanism.

FIG. 4 is a block representation of a mobile handset with an application client according to one embodiment of the disclosure.

FIG. 5 is a block representation of a call control application server according to one embodiment of the disclosure.

### DETAILED DESCRIPTION OF THE PREFERRED EMBODIMENT

The embodiments set forth below represent the necessary information to enable those skilled in the art to practice the invention and illustrate the best mode of practicing the invention. Upon reading the following description in light of the accompanying drawings, those skilled in the art will understand the concepts of the invention and will recognize applications of these concepts not particularly addressed herein. It should be understood that these concepts and applications fall within the scope of the disclosure and the accompanying claims.

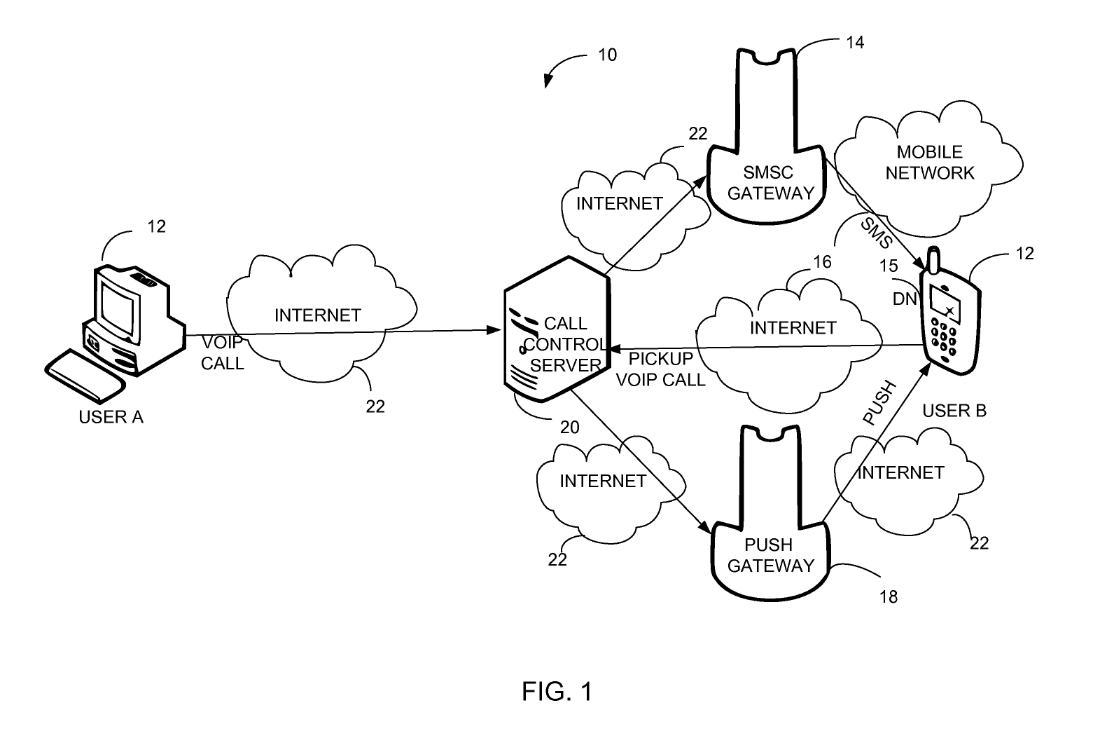

Prior to delving into the details of select embodiments, an overview of an exemplary communication environment 10 is provided in association with FIG. 1. In general, a call control application server (CCAS) 20 is provided to facilitate call establishment between two phones and to connect incoming VOIP call by making a VOIP pickup call to the server. The call control application server (CCAS) 20 that is receiving VOIP call will send notification to the device by using push notification, SMS or another mechanism through SMSC gateway 14, push gateway 18 or others. In an exemplary embodiment, the mobile handset 12 is equipped with application client whom monitors incoming notifications that contain parameters of pickup call parameters (Replaces header can be used, but other proprietary mechanisms can be used as well). After receiving this call pickup information through SMS or push notification the mobile phone of user B 12 will make a VOIP call to the server with correspondent parameters in a call. After receiving this pickup call request the call control application server (CCAS) 20 will correlate the initial incoming VOIP call with the VOIP pickup call and complete the initial incoming call kept by CCAS 20.

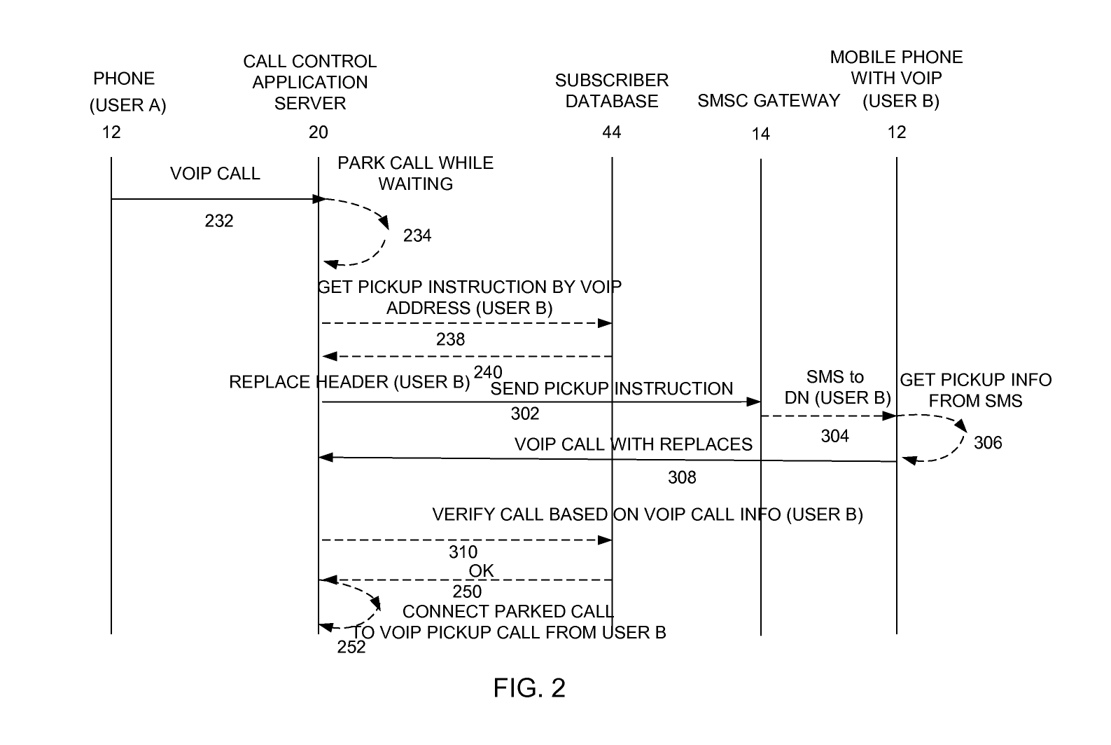

With reference to FIG. 2, a communication flow is provided to illustrate an exemplary scenario for utilizing the call control application server 20 to set up a voice call between user A and user B equipped with VOIP enabled application client 30. This is only an exemplary scenario of voice call establishment between two phones and the aspects and elements represented in the communication flow are not all deemed necessary for implementation of the present invention. For purposes of clarity, the phone 12 (which could be a voip client on mobile phone or on desktop computer) of user A associated with DN A is labelled “Phone (user A) 12”. Likewise the mobile handset 12 of user B associated with DN B and equipped with VOIP is labelled “Mobile Phone with VOIP (user B) 12”. The call control application server 20 operates to accept incoming VOIP call from users. The subscriber database 44 operates to store user profile information and to provide this information to the service application 40 as requested. In exemplary embodiments, the user database 44 may form a part of the call control application server 20.

At some point, the user A decides to initiate a VOIP call from the phone (user A) 12 to the phone (user B) 12 (step 232) though it's VOIP address.

The call control application server (CCAS) 20 is receiving an inbound VOIP call request (step 232), extracting the calling number (user A's DN) and parking the call (step 234).

Now in possession of user B's VOIP address the call control application server (CCAS) 20 matches it with information in subscriber's database 44 (step 238) and retrieves the called number (user B's DN 15) and necessary pick up information (for example, necessary information to construct Replaces header) to formulate an assisting SMS with given pick up instructions (step 302).

This information will be sent to the SMSC gateway 14 through corresponding communication interface (step 302). In exemplary scenario RESTful API 22 is used as such interface but it can be any type of inter services connectivity.

Next, the SMS gateway 14 sends assisting SMS (SMSAM) message to user B's DN 15 (step 304) as originated from user B's VOIP address.

The application client 30 in phone (user B) 12 will intercept this incoming assisting SMS message, identify that it is a message from the call control application server (CCAS) 20 and extract pick up information (step 306). At the same time the application client will initiate a VOIP call to the server with correspondent parameters in a call (step 308).

The call control application server (CCAS) 20 is receiving an inbound VOIP call request from user B's DN and extracting corresponding instruction (Replaces headers, e.g.).

Now in possession of user B's DN, and pickup instructions the call control application server (CCAS) 20 matches it with information in subscriber's database 44 (step 310) and retrieves the initial parked call leg (step 250).

Now the call control application server (CCAS) 20 connects the initial parked call leg and incoming VOIP pickup call and connects the subscriber to the called number (step 252).

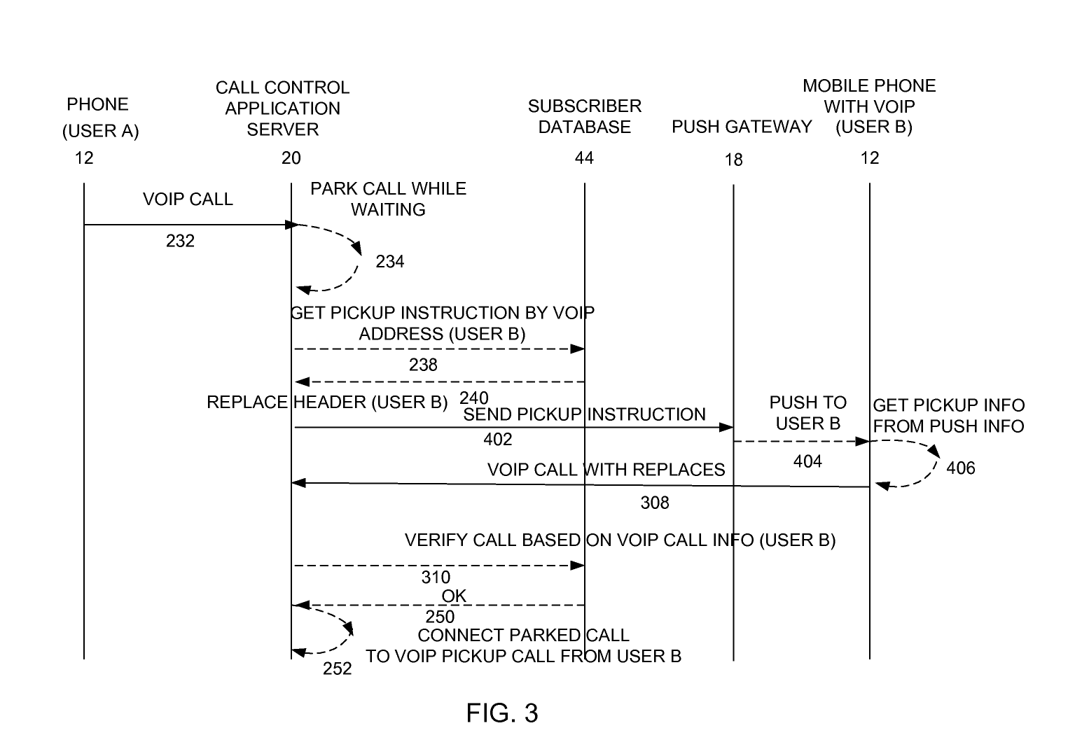

With reference to FIG. 3, a communication flow is provided to illustrate an exemplary scenario for utilizing the call control application server 20 to set up a voice call between user A and user B equipped with application client 30. This is only an exemplary scenario of voice call establishment between two phones, where the call control application server (CCAS) 20 is using push messaging as notification mechanism to provide call pickup information to user's B handset equipped with the application client 30.

The call control application server (CCAS) 20 is receiving an inbound VOIP call request (step 232), extracting the calling number (user A's DN) and called VOIP number for user B (which is not necessary is the same as user B mobile DN) and parking the call (step 234).

Now in possession of user VOIP B's DN the call control application server (CCAS) 20 matches it with information in subscriber's database 44 (step 238), retrieve user B's mobile DN and necessary pick up information and necessary pick up information (for example, necessary information to construct Replaces header) (step 240) to formulate an assisting push message with given pick up instructions.

This information will be sent to the push gateway 18 through corresponding communication interface (step 402). In exemplary scenario RESTful API 22 is used as such interface but it can be any type of inter services connectivity.

Next, the push gateway 18 sends assisting push message to user B's DN 15 (step 404).

The application client 30 in phone (user B) 12 will receive this push message, identify that it is a message from the call control application server (CCAS) 20 and extract pick up information (step 406 At the same time the application client will initiate a VOIP call to the server with correspondent parameters in a call (step 308).

The call control application server (CCAS) 20 is receiving an inbound VOIP call request from user B's DN and extracting corresponding instruction (Replaces headers, e.g.).

Now in possession of user B's DN, and pickup instructions the call control application server (CCAS) 20 matches it with information in subscriber's database 44 (step 310) and retrieves the initial parked call leg (step 250).

Now the call control application server (CCAS) 20 connects the initial parked call leg and incoming VOIP pickup call and connects the subscriber to the called number (step 252).

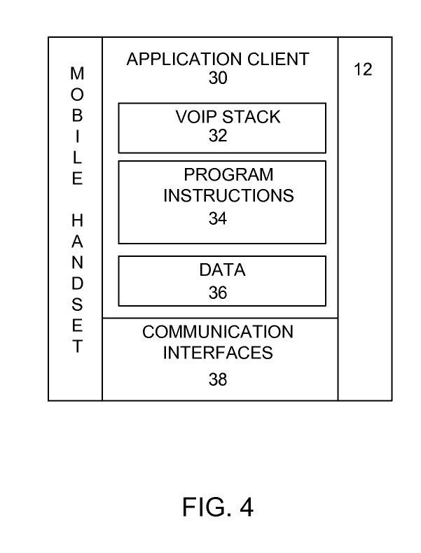

With reference to FIG. 4, a block representation of the mobile handset (smartphone) 12 with an application client 30 is illustrated according to one embodiment. The mobile handset 12 includes an application client 30 having VOIP capability 32 and program instructions 34 and data 36 to operate as described above. The program instructions 34 provide the communication functions, data storage and gathering functions which are described above. The application client 30 can interact with three communication interfaces 38 (SMS, push notification and VOIP call setup through data network) to gather additional information through SMS assisting message or push message and to establish a VOIP call as illustrated in the communication environment 10.

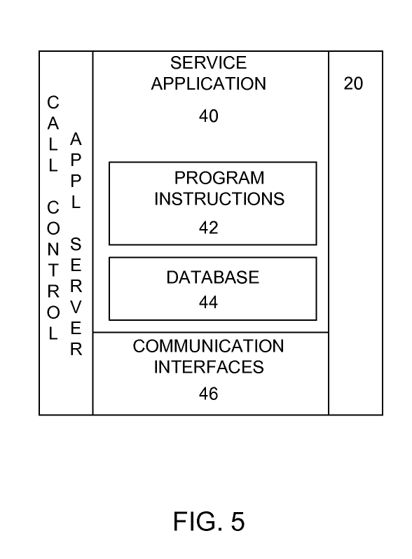

With reference to FIG. 5, a block representation of a call control application server 20 is illustrated. The call control application server 20 includes a service application 40 having capability to store and retrieve subscriber and call specific data in database 44 and program instructions 42 for initiating SMS assisting message or push notification, accepting and control VOIP call requests as described above. The service application 40 interacts with through several communication interfaces 48 with SMS gateways, push gateway, IP (Internet) and mobile network to provide call control functionality as described above.

Those skilled in the art will recognize improvements and modifications to the embodiments of the present invention. All such improvements and modifications are considered within the scope of the concepts disclosed herein and the claims that follow.

1. A method for receiving incoming VOIP call without maintaining of permanent SIP registration comprising: receiving initial incoming VOIP call through the call control application server (CCAS); keeping this initial call request by CCAS and notifying user's mobile phone equipped with mobile application by sending notification to this application; retrieving of parameters of pickup call from notification message or from configuration on the phone by mobile application; making a VOIP pickup call from this mobile phone with appropriate parameters (Replaces header can be used, but other proprietary mechanisms can be used as well); holding initial incoming call until CCAS receives an incoming VOIP pickup call from the user device and after that completing the call.

2. The method as claimed in claim 1 wherein sending notification to the device comprises providing parameters of VOIP pickup call within notification message.

3. The method as claimed in claim 1 wherein receiving notification about incoming call on the device comprises getting parameters of VOIP pickup call from local configuration on user's mobile phone.

4. The method as claimed in claim 2 wherein receiving parameters of VOIP pickup within notification message further comprises initiating VOIP pickup call with appropriate parameters (Replaces header can be used, but other proprietary mechanisms can be used as well) by special application integrated with a native dialler.

5. The method as claimed in claim 3 wherein getting parameters of VOIP pickup call from local configuration further comprises initiating VOIP pickup call with appropriate parameters (Replaces header can be used, but other proprietary mechanisms can be used as well) by special application integrated with a native dialler.

6. The method as claimed in claim 1 further comprising: receiving VOIP pickup call request at the CCAS; correlating this VOIP pickup call request with initial VOIP incoming call based on information provided in VOIP pickup call; completing the connection between VOIP pickup call and initial incoming VOIP call kept by CCAS.

7. A system for receiving incoming VOIP call without maintaining of permanent SIP registration, comprising: a mobile phone equipped with application client programmed to: monitor notification about incoming VOIP calls from a call control server (CCAS); retrieve parameters of pickup call from notification message or from configuration on the phone by mobile application; make a VOIP pickup call from this mobile phone with appropriate parameters (Replaces header can be used, but other proprietary mechanisms can be used as well); and a call control application server (CCAS), comprising a service programmed to: receive initial incoming VOIP call; keep this initial call request and send notification about the call request to the application on user's mobile phone; wait for incoming VOIP pickup call from the subscriber mobile phone; correlate this VOIP pickup call request with initial VOIP incoming call based on information provided in VOIP pickup call and complete the connection between them.

8. A call control application server as claimed in claim 7 wherein receiving VOIP calls further comprises a service application which sending notification to the device by using push notification, SMS or another mechanism.

9. A call control application server as claimed in claim 7 wherein sending notification to the device comprises a service application that providing parameters of VOIP pickup call within notification message.

10. The application client as claimed in claim 7 wherein receiving notification from the server about incoming VOIP call further comprises program instructions for retrieving parameters of VOIP pickup call from this notification message prior to initiating of VOIP pickup call.

11. The application client as claimed in claim 7 wherein receiving notification from the server about incoming VOIP call further comprises program instructions for retrieving parameters of VOIP pickup call from local configuration prior to initiating of VOIP pickup call.

12. A call control application server, comprising: a service application that receives VOIP pickup call request; correlates this VOIP pickup call request with initial VOIP incoming call based on information provided in VOIP pickup call; completes the call setup request to connect the subscriber to the initial VOIP incoming call.
